(19) United States
(12) Patent Application Publication
(10) Pub. No.: US 2026/0171317 A1
(43) Pub. Date: Jun. 18, 2026

(54) CAPACITOR

(71) Applicant: NICHICON CORPORATION, Kyoto-shi (JP)

(72) Inventors: Yusuke NAKATA, Kyoto-shi (JP); Takashi MORI, Kyoto-shi (JP); Masaya YAMAMOTO, Kyoto-shi (JP)

(21) Appl. No.: 19/530,807

(22) Filed: Feb. 5, 2026

Related U.S. Application Data
(63) Continuation of application No. PCT/JP2024/022752, filed on Jun. 24, 2024.

(30) Foreign Application Priority Data
Nov. 8, 2023 (JP) 2023-190578

(51) Int. Cl. H01G 4/224

(52) U.S. Cl. CPC H01G 4/224

(57) ABSTRACT

Moisture entering a capacitor element is prevented. A capacitor having: a capacitor element including first and second end face electrodes; first and second bus bars electrically connected to the first and second end face electrodes; an insulating member including a first-bus-bar-facing surface having a plurality of first protrusions and a second-bus-bar-facing surface having a plurality of second protrusions; and a sealing resin filling a housing space housing a case, the capacitor element, part of the first and second bus bars, and part of the insulating member, in which the plurality of first protrusions and the plurality of second protrusions are arranged separated in a first direction perpendicular to the resin surface of the sealing resin, and at least one of the plurality of first protrusions and at least one of the plurality of second protrusions are embedded in the sealing resin.

### CROSS-REFERENCE TO RELATED APPLICATIONS

This application is a continuation application of PCT International Application No. PCT/JP2024/022752, filed on Jun. 24, 2024, which claims the priority benefit of Japanese Patent Application No. 2023-190578, filed on Nov. 8, 2023, the entire contents of which are hereby incorporated by reference.

### BACKGROUND

### 1. Technical Field

The present invention relates to capacitors having an insulating member that is disposed between a pair of bus bars and insulates each of the pair of bus bars from the other.

### 2. Description of the Background

A conventional capacitor includes a capacitor element, a pair of bus bars, an insulating member, a case, and a sealing resin. The capacitor element includes a pair of end face electrodes. The pair of bus bars is electrically connected to the pair of end face electrodes of the capacitor element. The insulating member, which is disposed between the pair of bus bars, insulates each of the pair of bus bars from the other. The case houses, in its housing space, the capacitor element, part of the pair of bus bars, and part of the insulating member. The sealing resin fills the housing space housing the capacitor element, the part of the pair of bus bars, and the part of the insulating member.

A plurality of ribs are formed on facing surfaces of the insulating member that face the respective ones of the pair of bus bars. Thereby, the pair of bus bars is maintained in a parallel state (e.g., WO 2017/146013).

### BRIEF SUMMARY

The performance of a capacitor element deteriorates due to moisture. Therefore, to prevent moisture from entering the capacitor element, the capacitor element is sealed in by a sealing resin such as an epoxy resin.

However, in the conventional technology in which the ribs are formed in strip shapes along the height direction (the direction perpendicular to the resin surface of the sealing resin) on the facing surfaces of the insulating member that face the respective ones of the pair of bus bars, there are no gaps between the strip-shaped ribs and the bus bars. Thereby, the wicking of the sealing resin is hindered, and there is a concern that moisture may enter the capacitor element from between each of the pair of bus bars and the insulating member.

An object of the present invention is to provide a capacitor that can prevent moisture from entering a capacitor element.

A first aspect of the present invention provides a capacitor including:
a capacitor element including a first end face electrode and a second end face electrode;
a first bus bar electrically connected to the first end face electrode;
a second bus bar electrically connected to the second end face electrode;
an insulating member disposed between the first bus bar and the second bus bar, and the insulating member insulating the first bus bar from the second bus bar, the insulating member including:
   a first-bus-bar-facing surface having a plurality of first protrusions and facing the first bus bar; and
   a second-bus-bar-facing surface having a plurality of second protrusions and facing the second bus bar;
a case that houses, in a housing space, the capacitor element, part of the first bus bar, part of the second bus bar, and part of the insulating member; and
a sealing resin filling the housing space housing the capacitor element, the part of the first bus bar, the part of the second bus bar, and the part of the insulating member, wherein
a plurality of the first protrusions and a plurality of the second protrusions are arranged separated from each other in a first direction perpendicular to a resin surface of the sealing resin, and
at least one of a plurality of the first protrusions and at least one of a plurality of the second protrusions are embedded in the sealing resin.

The capacitor of the present invention can prevent moisture from entering the capacitor element.

### BRIEF DESCRIPTION OF DRAWINGS

FIG. 1 is a perspective view of a capacitor according to an embodiment.

FIG. 2 is a perspective view of the capacitor from which a sealing resin in FIG. 1 is removed.

FIG. 3 is an exploded perspective view of the capacitor from which the sealing resin in FIG. 1 is removed.

FIG. 4 is a schematic diagram of part of a cross section taken along a line A-A in FIG. 1.

FIG. 5A is a perspective view of an insulating member according to the embodiment, and FIG. 5B is a perspective view of the insulating member as seen in a direction different from the direction in FIG. 5A.

FIGS. 6A and 6B are drawings for explaining a process of manufacturing the capacitor.

FIGS. 7A and 7B are drawings for explaining the process of manufacturing the capacitor.

FIGS. 8A and 8B are drawings for explaining the process of manufacturing the capacitor.

### DETAILED DESCRIPTION

Hereinafter, an embodiment of the present invention is explained in detail with reference to the attached drawings.

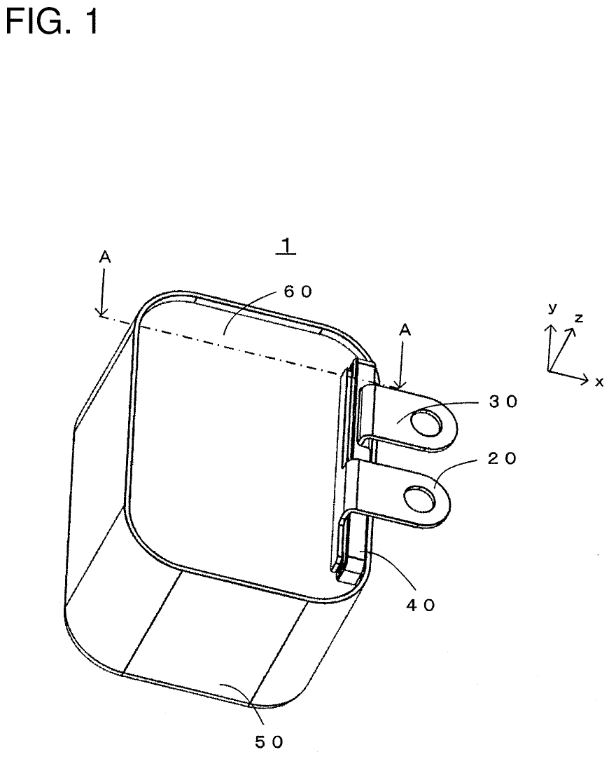

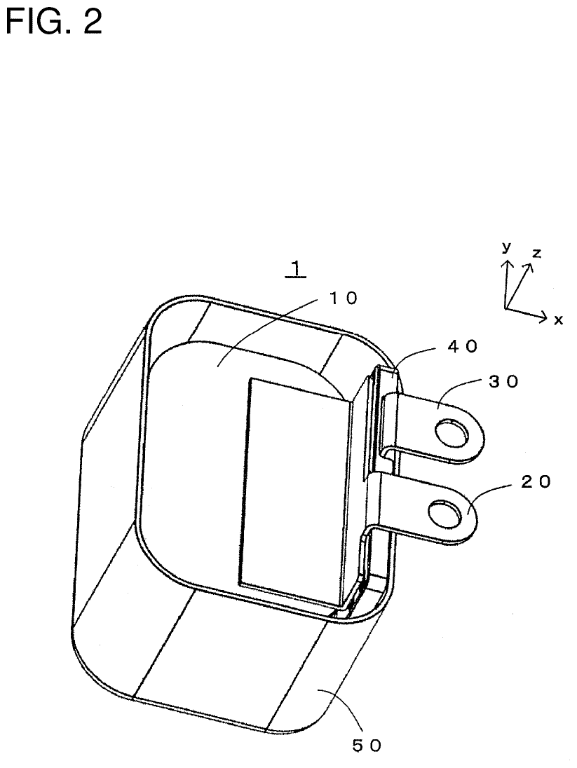

First, the structure of a capacitor 1 according to the embodiment is explained with reference to FIG. 1 to FIG. 5B. Hereinafter, a plan view of the capacitor 1 as seen along the z axis is referred to as “xy plan view,” a plan view of the capacitor 1 as seen along the x axis is referred to as “yz plan view,” and a plan view of the capacitor 1 as seen along the y axis is referred to as “zx plan view.”

As illustrated in FIG. 1 to FIG. 4, the capacitor 1 includes a metallized film capacitor element (one metallized film capacitor element 10 in the present embodiment:
hereinafter referred to as “capacitor element”), a first bus bar 20, a second bus bar 30, an insulating member 40, a case 50, and a sealing resin 60.

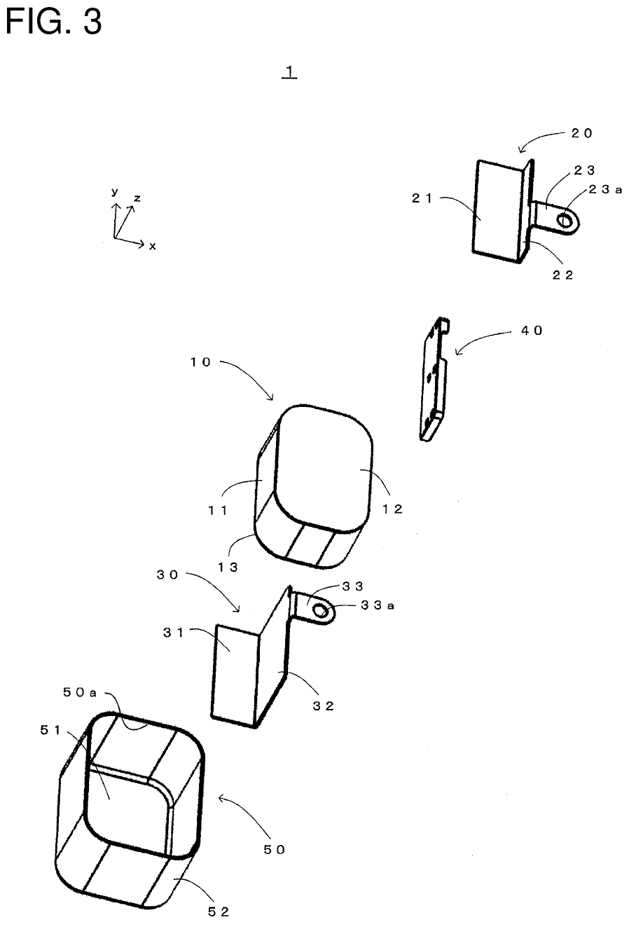

As illustrated in FIG. 3, the capacitor element 10 includes an element body 11, a first end face electrode 12, and a second end face electrode 13. The first end face electrode 12 is formed by spraying a metal such as zinc on a first end face of the element body 11. The second end face electrode 13 is formed by spraying a metal such as zinc on a second end face of the element body 11.

The element body 11 is formed by laminating two metallized films obtained by vapor deposition of aluminum on dielectric films, winding or stacking the laminated metallized films, and pressing the wound or stacked metallized films into a flat shape.

Note that, whereas the element body 11 of the present embodiment is formed of the metallized films obtained by vapor deposition of aluminum on the dielectric films, the present invention is not limited to this. For example, the element body 11 may be formed of metallized films obtained by vapor deposition of another metal such as zinc or magnesium. The element body 11 may be formed of metallized films obtained by vapor deposition of a plurality of metals selected from metals such as aluminum, zinc, and magnesium. The element body 11 may be formed of metallized films obtained by vapor deposition of an alloy of the metals.

In the present embodiment, the first end face electrode 12 is used as the P-pole side, and the second end face electrode 13 is used as the N-pole side. Note that the first end face electrode 12 may be used as the N-pole side, and the second end face electrode 13 may be used as the P-pole side.

Each of the first bus bar 20 and the second bus bar 30 is formed of a conductive material such as copper.

The first bus bar 20 has a shape illustrated in FIG. 3. The first bus bar 20 of the present embodiment is used as the P-pole-side bus bar. Note that the first bus bar 20 may be used as the N-pole-side bus bar.

The first bus bar 20 includes an element connection electrode planar section 21, a lead-out section 22, and an external connection terminal 23.

The element connection electrode planar section 21 has a plate-like shape whose outer profile in the xy plan view is substantially rectangular. The element connection electrode planar section 21 is sufficiently close to the first end face electrode 12 of the capacitor element 10 to allow soldering thereto.

The lead-out section 22 has a plate-like shape whose outer profile in the yz plan view is substantially rectangular. The lead-out section 22 extends in the z-axis positive direction from an end of the element connection electrode planar section 21 on the x-axis positive side.

The external connection terminal 23 has a plate-like shape. The external connection terminal 23 extends in the x-axis positive direction from an end of the lead-out section 22 opposite to the element connection electrode planar section 21. A penetrating section 23a is formed through the external connection terminal 23. The penetrating section 23a has a substantially circular shape in the xy plan view. The first bus bar 20 and an external wire are fastened using the penetrating section 23a.

The second bus bar 30 has a shape illustrated in FIG. 3. The second bus bar 30 of the present embodiment is used as the N-pole-side bus bar. Note that the second bus bar 30 may be used as the P-pole-side bus bar.

The second bus bar 30 includes an element connection electrode planar section 31, a lead-out section 32, and an external connection terminal 33.

The element connection electrode planar section 31 has a plate-like shape whose outer profile in the xy plan view is substantially rectangular. The element connection electrode planar section 31 is sufficiently close to the second end face electrode 13 of the capacitor element 10 to allow soldering thereto in the state where the capacitor 1 has been assembled.

The lead-out section 32 has a plate-like shape whose outer profile in the yz plan view is substantially rectangular. The lead-out section 32 extends in the z-axis positive direction from an end of the element connection electrode planar section 31 on the x-axis positive side.

The external connection terminal 33 has a plate-like shape. The external connection terminal 33 extends in the x-axis positive direction from an end of the lead-out section 32 opposite to the element connection electrode planar section 31. A penetrating section 33a is formed through the external connection terminal 33. The penetrating section 33a has a substantially circular shape in the xy plan view. The second bus bar 30 and an external wire are fastened using the penetrating section 33a.

An insulating body 41 of the insulating member 40 is disposed between the lead-out section 22 of the first bus bar 20 and the lead-out section 32 of the second bus bar 30. Thereby, the first bus bar 20 is insulated from the second bus bar 30.

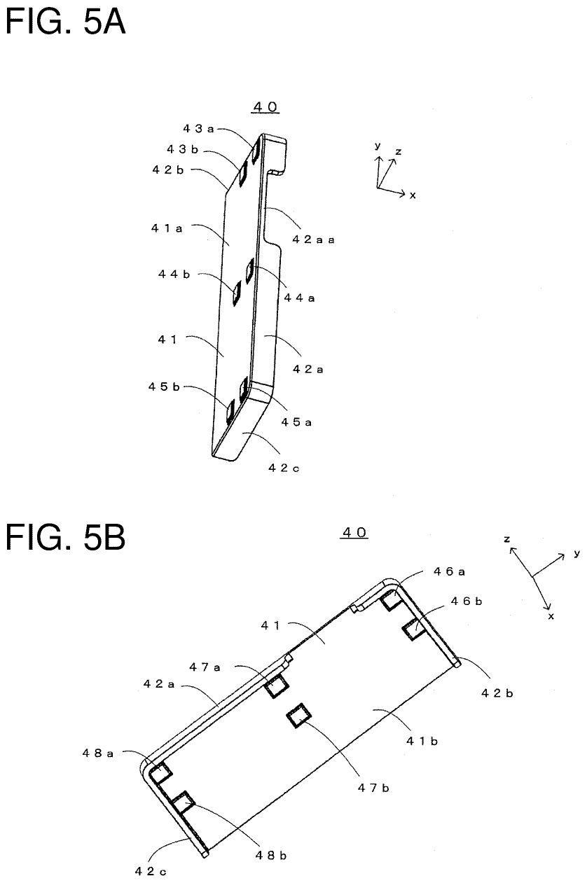

For example, the insulating member 40 is formed of a resin such as polyphenylene sulfide (PPS) or polybutylene terephthalate (PBT). The insulating member 40, which has insulation properties, has a shape illustrated in FIGS. 5A and 5B.

The insulating member 40 includes the insulating body 41, an insulation top section 42a, a first insulating side section 42b, and a second insulating side section 42c.

The insulating body 41 has a plate-like shape whose outer profile in the yz plan view is substantially rectangular. The insulating body 41 is disposed between the lead-out section 22 and the lead-out section 32.

The insulation top section 42a extends in the x-axis positive direction from an end of the insulating body 41 on the z-axis positive side. The first insulating side section 42b extends in the x-axis positive direction from an end of the insulating body 41 on the y-axis positive side. The second insulating side section 42c extends in the x-axis positive direction from an end of the insulating body 41 on the y-axis negative side. A cutout 42aa is formed at the insulation top section 42a. A side of the lead-out section 32 of the second bus bar 30 close to the external connection terminal 33 is inserted to the cutout 42aa.

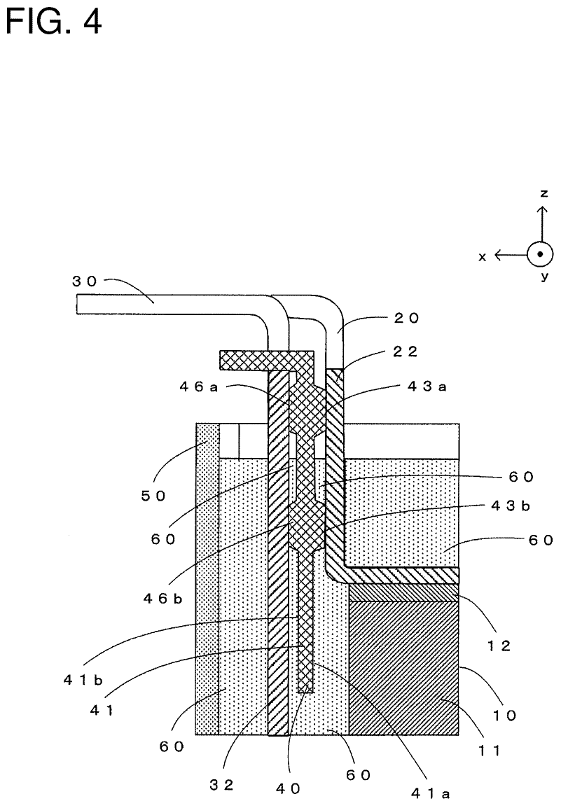

The insulating body 41 includes a first-bus-bar-facing surface 41a. The first-bus-bar-facing surface 41a faces the lead-out section 22 of the first bus bar 20. As illustrated in FIG. 4 and FIG. 5A, protrusions (first protrusions) 43a, 43b, 44a, 44b, 45a, and 45b are formed on the first-bus-bar-facing surface 41a. The protrusions 43a, 43b, 44a, 44b, 45a, and 45b have truncated pyramid shapes (truncated rectangular pyramid shapes in the present embodiment) protruding from the first-bus-bar-facing surface 41a.

The protrusions 43a and 43b are formed at an end of the first-bus-bar-facing surface 41a on the y-axis positive side. The protrusions 43a and 43b are formed spaced apart from each other in the z-axis direction. That is, in a case where the z-axis positive side is regarded as the “upper” side, and the z-axis negative side is regarded as the “lower” side, the protrusions 43a and 43b (first protrusion group) are arranged, in the up-down direction, separated from each other.

The protrusions 44a and 44b are formed at a central section of the first-bus-bar-facing surface 41a in the y-axis direction. The protrusions 44a and 44b are formed spaced apart from each other in the z-axis direction. That is, the protrusions 44a and 44b (first protrusion group) are arranged, in the up-down direction, separated from each other.

The protrusions 44a and 44b are arranged spaced apart from the protrusions 43a and 43b. The protrusions 44a and 44b are arranged spaced apart from the protrusions 45a and 45b.

The protrusions 45a and 45b are formed at an end of the first-bus-bar-facing surface 41a on the y-axis negative side. The protrusions 45a and 45b are formed spaced apart from each other in the z-axis direction. That is, the protrusions 45a and 45b (first protrusion group) are arranged, in the up-down direction, separated from each other.

As illustrated in FIG. 4, the protrusions 43a, 44a, and 45a are exposed outside the sealing resin 60. The protrusions 43b, 44b, and 45b are embedded in the sealing resin 60.

The insulating body 41 includes a second-bus-bar-facing surface 41b. The second-bus-bar-facing surface 41b faces the lead-out section 32 of the second bus bar 30. As illustrated in FIG. 4 and FIG. 5B, protrusions (second protrusions) 46a, 46b, 47a, 47b, 48a, and 48b are formed on the second-bus-bar-facing surface 41b. The protrusions 46a, 46b, 47a, 47b, 48a, and 48b have truncated pyramid shapes (truncated rectangular pyramid shapes in the present embodiment) protruding from the second-bus-bar-facing surface 41b.

The protrusions 46a and 46b are formed at an end of the second-bus-bar-facing surface 41b on the y-axis positive side. The protrusions 46a and 46b are formed spaced apart from each other in the z-axis direction. That is, the protrusions 46a and 46b (second protrusion group) are arranged, in the up-down direction, separated from each other.

The protrusions 47a and 47b are formed at a central section of the second-bus-bar-facing surface 41b in the y-axis direction. The protrusions 47a and 47b are formed spaced apart from each other in the z-axis direction. That is, the protrusions 47a and 47b (second protrusion group) are arranged, in the up-down direction, separated from each other.

The protrusions 47a and 47b are arranged spaced apart from the protrusions 46a and 46b. The protrusions 47a and 47b are arranged spaced apart from the protrusions 48a and 48b.

The protrusions 48a and 48b are formed at an end of the second-bus-bar-facing surface 41b on the y-axis negative side. The protrusions 48a and 48b are formed spaced apart from each other in the z-axis direction. That is, the protrusions 48a and 48b (second protrusion group) are arranged, in the up-down direction, separated from each other.

As illustrated in FIG. 4, the protrusions 46a, 47a, and 48a are exposed outside the sealing resin 60. The protrusions 46b, 47b, and 48b are embedded in the sealing resin 60.

For example, the thickness of the insulating body 41 (the thickness in the x-axis direction) is equal to or greater than 0.5 mm and equal to or smaller than 1.2 mm. The height of the protrusions 46a, 46b, 47a, 47b, 48a, and 48b (the height in the x-axis direction) is equal to or greater than 0.1 mm and equal to or smaller than 0.5 mm.

For example, the case 50 may be formed of various materials such as organic materials including resins, plastics, and the like such as polyphenylene sulfide (PPS) or polybutylene terephthalate (PBT) and inorganic materials such as ceramics.

The case 50 has a shape illustrated in FIG. 3. The case 50 includes a bottom section 51 and a side section 52. The case 50 has a box shape with its surface on the z-axis positive side opened. The inner surface of the bottom section 51 is a flat surface parallel to the xy plane.

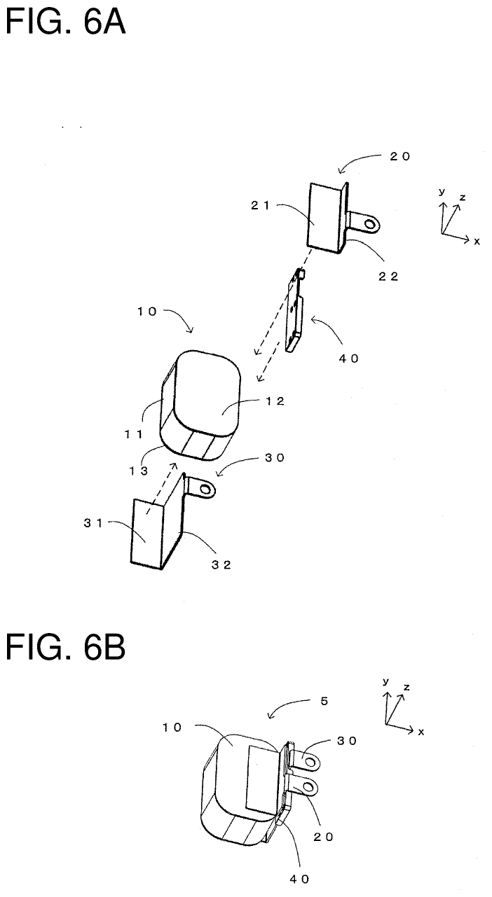

A capacitor unit 5 includes the capacitor element 10, the first bus bar 20, the second bus bar 30, and the insulating member 40. As illustrated in FIG. 6B, part of the capacitor unit 5 is housed in the housing space of the case 50. Specifically, the capacitor element 10, part of the first bus bar 20, part of the second bus bar 30, and part of the insulating member 40 are housed in the housing space of the case 50.

As illustrated in FIG. 4, the sealing resin 60 fills the housing space of the case 50 housing the part of the capacitor unit 5, and seals in the capacitor element 10 and the like. For example, the sealing resin 60 is an epoxy resin.

Note that the sealing resin 60 is not limited to an epoxy resin, and various insulation materials that are adopted as sealing resins of electronic components can be used as the sealing resin 60. The sealing resin 60 is formed by being injected in a liquid state through an opening 50a of the case 50 and then cured.

As illustrated in FIG. 4, the sealing resin 60 of the present embodiment fills the housing space of the case 50 up to a filling height position in a direction (z-axis direction) perpendicular to the inner surface of the bottom section 51 of the case 50. Here, the filling height position is a position between the protrusions 43a to 48a and the protrusions 43b to 48b of the insulating member 40. In a case where the sealing resin 60 fills the housing space in this manner, the whole of the capacitor element 10, the portion of the first bus bar 20 positioned at and lower than the filling height position, the portion of the second bus bar 30 positioned at and lower than the filling height position, and the portion of the insulating member 40 positioned at and lower than the filling height position are located inside the sealing resin 60. The protrusions 43a to 48a are not embedded in the sealing resin 60 but are exposed outside the sealing resin 60. The protrusions 43b to 48b are embedded in the sealing resin 60.

A gap is formed between the lead-out section 22 of the first bus bar 20 and a portion of the insulating body 41 other than the protrusions 43a to 45a and 43b to 45b due to the protrusions 43a to 45a and 43b to 45b. The sealing resin 60 fills the gap.

In addition, a gap is formed between the lead-out section 32 of the second bus bar 30 and a portion of the insulating body 41 other than the protrusions 46a to 48a and 46b to 48b due to the protrusions 46a to 48a and 46b to 48b. The sealing resin 60 fills the gap.

Hereinafter, a process of manufacturing the capacitor 1 with the structure mentioned above is explained with reference to FIG. 6A to FIG. 8. Note that the process of manufacturing the capacitor 1 explained below is an example, and the capacitor 1 may be manufactured in any assembly order as long as the capacitor 1 can be assembled in the state illustrated in FIG. 1 in the end.

In FIG. 6A, the capacitor element 10 and the insulating member 40 are arranged such that the insulating body 41 and a side surface of the capacitor element 10 face each other.

In addition, the second bus bar 30 is disposed with respect to the capacitor element 10 and the insulating member 40 such that the second-bus-bar-facing surface 41b of the insulating body 41 and the lead-out section 32 of the second bus bar 30 face each other, and the second end face electrode 13 and the element connection electrode planar section 31 are brought sufficiently close to each other to allow soldering therebetween.

In addition, the first bus bar 20 is disposed with respect to the capacitor element 10 and the insulating member 40 such that the first-bus-bar-facing surface 41a of the insulating body 41 and the lead-out section 22 of the first bus bar 20 face each other, and the first end face electrode 12 and the element connection electrode planar section 21 are brought sufficiently close to each other to allow soldering therebetween.

The second bus bar 30 is electrically connected to the second end face electrode 13 by soldering the element connection electrode planar section 31 to the second end face electrode 13. In addition, the first bus bar 20 is electrically connected to the first end face electrode 12 by soldering the element connection electrode planar section 21 to the first end face electrode 12. Thereby, the state illustrated in FIG. 6B is achieved, and the capacitor unit 5, in which the capacitor element 10, the first bus bar 20, the second bus bar 30, and the insulating member 40 are assembled, is completed.

The insulating body 41 is disposed between the lead-out section 22 of the first bus bar 20 and the lead-out section 32 of the second bus bar 30. A gap is formed between the lead-out section 22 and a portion of the insulating body 41 other than the protrusions 43a to 45a and 43b to 45b due to the protrusions 43a to 45a and 43b to 45b. A gap is formed between the lead-out section 32 and a portion of the insulating body 41 other than the protrusions 46a to 48a and 46b to 48b due to the protrusions 46a to 48a and 46b to 48b.

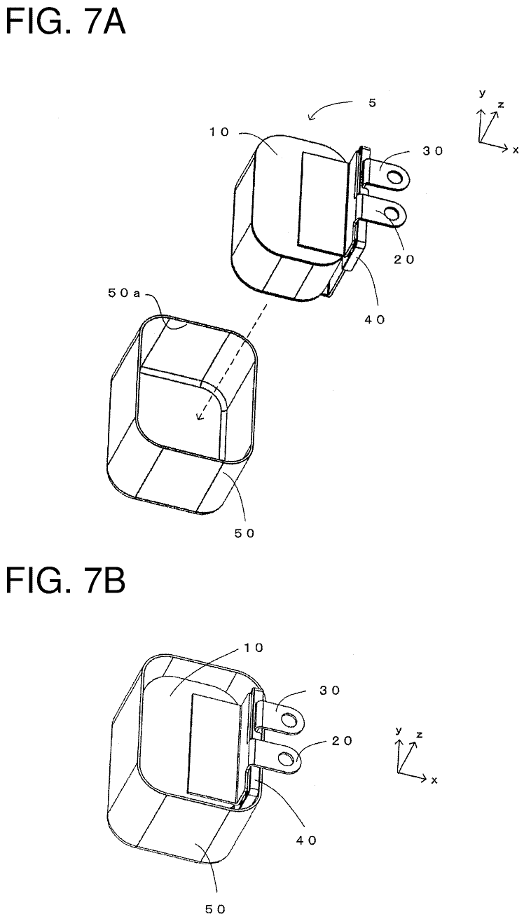

In FIG. 7A, part of the capacitor unit 5 (the capacitor element 10, part of the first bus bar 20, part of the second bus bar 30, and part of the insulating member 40) is housed in the housing space of the case 50 through the opening 50a. Thereby, the state illustrated in FIG. 7B is achieved.

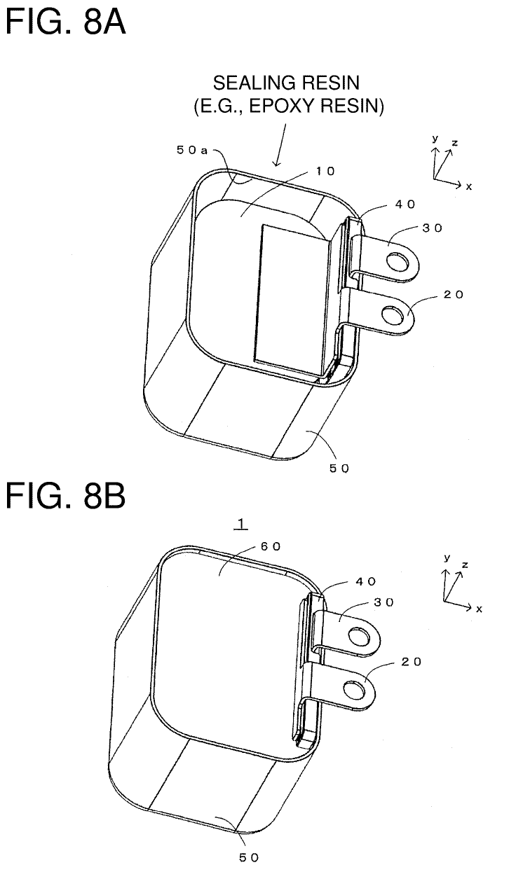

In the state where the part of the capacitor unit 5 is housed in the housing space of the case 50, as illustrated in FIG. 8A, the sealing resin 60 such as a liquid epoxy resin is injected through the opening 50a of the case 50 and is cured at a predetermined curing temperature. Thereby, the capacitor 1 illustrated in FIG. 8B is completed.

Note that the injected sealing resin 60 gradually fills the housing space of the case 50 while wicking upward from the lower side through the gap formed between the lead-out section 22 and the insulating body 41 and wicking upward from the lower side through the gap formed between the lead-out section 32 and the insulating body 41.

As illustrated in FIG. 4, the sealing resin 60 of the present embodiment fills the housing space of the case 50 up to the position (filling height position) between the protrusions 43a to 48a and the protrusions 43b to 48b in the direction (z-axis direction) perpendicular to the inner surface of the bottom section 51 of the case 50. In a case where the sealing resin 60 fills the housing space in this manner, the protrusions 43a to 48a are not embedded in the sealing resin 60 but are exposed outside the sealing resin 60. In addition, the protrusions 43b to 48b are embedded in the sealing resin 60.

According to the present embodiment, the protrusions 43a to 45a and 46a to 48a and the protrusions 43b to 45b and 46b to 48b that are arranged in the direction (z-axis direction) perpendicular to the resin surface of the sealing resin 60 are formed separated from each other on the first-bus-bar-facing surface 41a and the second-bus-bar-facing surface 41b. The protrusions 43b to 45b and 46b to 48b are embedded in the sealing resin 60.

Thereby, gaps are surely formed between the lead-out section 22 and lead-out section 32 and the insulating body 41. As a result, the sealing resin 60 wicks between the lead-out section 22 and lead-out section 32 and the insulating member 40, and moisture entering the capacitor element 10 from between the lead-out section 22 and lead-out section 32 and the insulating member 40 can be prevented.

In addition, the protrusion group 43a and 43b and the protrusion group 45a and 45b are formed at both ends of the first-bus-bar-facing surface 41a in a direction (y-axis direction) parallel to the resin surface of the sealing resin 60. The protrusion group 44a and 44b is formed at a central section of the insulating body 41 in the y-axis direction.

Similarly, the protrusion group 46a and 46b and the protrusion group 48a and 48b are formed at both ends of the second-bus-bar-facing surface 41b in the y-axis direction. The protrusion group 47a and 47b is formed at the central section of the insulating body 41 in the y-axis direction.

Because of this, for example, even if the central section of the insulating body 41 warps to approach either one of the first bus bar 20 and the second bus bar 30, it is possible to prevent a portion other than the protrusions of the insulating body 41 and the first bus bar 20 or second bus bar 30 from contacting each other. In addition, even if the insulating body 41 inclines such that one end of the insulating body 41 approaches one of the first bus bar 20 and the second bus bar 30, and the other end of the insulating body 41 approaches the other of the first bus bar 20 and the second bus bar 30, it is possible to prevent a portion other than the protrusions of the insulating body 41 and the first bus bar 20 or the second bus bar 30 from contacting each other. Thereby, the wicking of the sealing resin between the insulating body 41 and the lead-out section 22 and lead-out section 32 effectively prevents moisture from entering the capacitor element 10.

The protrusions 43a to 48a arranged in the direction (z-axis direction) perpendicular to the resin surface of the sealing resin 60 are exposed outside the sealing resin 60, whereas the other protrusions 43b to 48b are embedded in the sealing resin 60. Thereby, moisture entering the capacitor element 10 from between the protrusions 43a to 48a and 43b to 48b and lead-out section 22 and the lead-out section 32 can be more effectively prevented.

In addition, various design modifications can be made to the configuration mentioned before within the scope of the matters described in claims.

For example, whereas the shapes of the protrusions 43a to 48a and 43b to 48b are truncated pyramid shapes in the embodiment described above, this is not the sole example. For example, the shapes of the protrusions 43a to 48a and 43b to 48b may be truncated cone shapes, rectangular pillar shapes such as rectangular parallelepiped, columnar shapes, or hemispherical shapes.

In addition, whereas three lines of protrusions (protrusion groups) that are separated in the z-axis direction are arranged in the direction (y-axis direction) parallel to the resin surface of the sealing resin 60 on each of the first-bus-bar-facing surface 41a and the second-bus-bar-facing surface 41b in the embodiment described above, the number of lines may be not three depending on the sizes of the bus bars in the y-axis direction or the like.

In addition, whereas the protrusions formed on each of the first-bus-bar-facing surface 41a and the second-bus-bar-facing surface 41b are formed at each of both ends and the central section of the insulating body 41 in the direction (y-axis direction) parallel to the resin surface of the sealing resin 60 in the embodiment described above, the protrusions may be arranged at other positions.

In addition, whereas the two protrusions (protrusion group) separated in the direction (z-axis direction) perpendicular to the resin surface of the sealing resin 60 are arranged on each of the first-bus-bar-facing surface 41a and the second-bus-bar-facing surface 41b in the embodiment described above, three or more protrusions may be arranged.

In addition, whereas some of a plurality of the protrusions formed on each of the first-bus-bar-facing surface 41a and the second-bus-bar-facing surface 41b are exposed outside the sealing resin 60, and the remaining part is embedded in the sealing resin 60 in the embodiment described above, all of the protrusions may be embedded in the sealing resin 60.

In addition, the content explained in the embodiment described above and the content explained in the modification examples described above may be combined as appropriate.

The present invention can be applied widely to capacitors having an insulating member that is disposed between a pair of bus bars and insulates each of the pair of bus bars from the other.

### REFERENCE SIGNS LIST

1: capacitor
10: capacitor element
11: element body
12: first end face electrode
13: second end face electrode
20: first bus bar
21: element connection electrode planar section
22: lead-out section
23: external connection terminal
30: second bus bar
31: element connection electrode planar section
32: lead-out section
33: external connection terminal
40: insulating member
41: insulating body
43a to 48a, 43b to 48b: protrusion
50: case
60: sealing resin

What is claimed is:

1. A capacitor comprising:
a capacitor element including a first end face electrode and a second end face electrode;
a first bus bar electrically connected to the first end face electrode;
a second bus bar electrically connected to the second end face electrode;
an insulating member disposed between the first bus bar and the second bus bar, and the insulating member insulating the first bus bar from the second bus bar, the insulating member including:
a first-bus-bar-facing surface having a plurality of first protrusions and facing the first bus bar; and
a second-bus-bar-facing surface having a plurality of second protrusions and facing the second bus bar;
a case that houses, in a housing space, the capacitor element, part of the first bus bar, part of the second bus bar, and part of the insulating member; and
a sealing resin filling the housing space housing the capacitor element, the part of the first bus bar, the part of the second bus bar, and the part of the insulating member, wherein
a plurality of the first protrusions and a plurality of the second protrusions are arranged separated from each other in a first direction perpendicular to a resin surface of the sealing resin, and
at least one of a plurality of the first protrusions and at least one of a plurality of the second protrusions are embedded in the sealing resin.

2. The capacitor according to claim 1, wherein
a plurality of the first protrusions include a plurality of first protrusion groups arranged in the first direction,
a plurality of the second protrusions include a plurality of second protrusion groups arranged in the first direction, and
a plurality of the first protrusion groups and a plurality of the second protrusion groups are formed at both ends and a central section of the insulating member in a second direction parallel to the resin surface.

3. The capacitor according to claim 1, wherein
at least one of a plurality of the first protrusions and at least one of a plurality of the second protrusions are exposed outside the sealing resin.

4. The capacitor according to claim 2, wherein
at least one of a plurality of the first protrusions and at least one of a plurality of the second protrusions are exposed outside the sealing resin.
